(19) United States
(12) Patent Application Publication
(10) Pub. No.: US 2026/0126926 A1
(43) Pub. Date: May 7, 2026

(54) MEMORY DEVICE WITH NEAR-MEMORY PROCESSING UNIT AND MEMORY MANAGEMENT

(71) Applicant: SAMSUNG ELECTRONICS CO., LTD., Suwon-si (KR)

(72) Inventors: Maksim OSTAPENKO, Suwon-si (KR); Deok Jae OH, Suwon-si (KR); Jihoon NAM, Suwon-si (KR)

(73) Assignee: SAMSUNG ELECTRONICS CO., LTD., Suwon-si (KR)

(21) Appl. No.: 19/378,765

(22) Filed: Nov. 4, 2025

(30) Foreign Application Priority Data
Nov. 4, 2024 (KR) 10-2024-0154361

(51) Int. Cl. G06F 3/06

(52) U.S. Cl. CPC G06F 3/064; G06F 3/061; G06F 3/0673

(57) ABSTRACT

A memory device includes: a memory storing instructions; and a processing unit including one or more processors, wherein the memory device is connected with a host processor through an interface, and wherein, the instructions, when executed by the processing unit, cause the memory device to: select, from among memory blocks stored in the memory, candidate hot memory blocks, the selecting based on access counts of the respective memory blocks stored in the memory; select a hot sub-block based on a number access counts of respective sub-blocks, including the hot sub-block, split from the selected candidate hot memory blocks; and transmit the selected hot sub-block to the host processor, based on a memory command regarding the hot sub-block, wherein the memory command is received from the host processor by the processing unit.

### CROSS-REFERENCE TO RELATED APPLICATIONS

This application claims the benefit under 35 USC § 119(a) of Korean Patent Application No. 10-2024-0154361, filed on Nov. 4, 2024, in the Korean Intellectual Property Office, the entire disclosure of which is incorporated herein by reference for all purposes.

### BACKGROUND

### 1. Field

The following description relates to a memory device with a near-memory processing unit and with technology for managing a memory.

### 2. Description of Related Art

In a large-scale computing environment, high-speed dynamic random-access memory (DRAM) increasingly dominates infrastructure spending, and this trend will only get worse without architectural improvement. Deployed memory costs may be reduced by replacing a portion of existing DRAM with a slower but cheaper memory media and establishing a tiered memory system in which two tiers are transparently directly addressable and cacheable as one memory space.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a memory device includes: a memory storing instructions; and a processing unit including one or more processors, wherein the memory device is connected with a host processor through an interface, and wherein, the instructions, when executed by the processing unit, cause the memory device to: select, from among memory blocks stored in the memory, candidate hot memory blocks, the selecting based on access counts of the respective memory blocks stored in the memory; select a hot sub-block based on a number access counts of respective sub-blocks, including the hot sub-block, split from the selected candidate hot memory blocks; and transmit the selected hot sub-block to the host processor, based on a memory command regarding the hot sub-block, wherein the memory command is received from the host processor by the processing unit.

The instructions, when executed by the processing unit, may cause the memory device to: select, as the candidate hot memory blocks, those of the memory blocks having access counts greater than a first access count threshold; split each of the selected candidate hot memory blocks into the sub-blocks; and select, the hot sub-block, from among the split sub-blocks, based on the hot sub-block having an access count that is greater than a second access count threshold.

The instructions, when executed by the processing unit, may cause the memory device to: determine the access counts of the respective memory blocks during a first time range; and determine the access counts each of the respective sub-blocks during a second time range that at least partially follows the first time range.

The first access count threshold may be determined based on a ratio of a time length of the first time range to a time length of a period including the first time range and the second time range.

A block size of the memory blocks may be larger than a block size of the sub-blocks.

The memory further may further include a hot buffer, wherein, the instructions, when executed by the processing unit, may cause the memory device to: store an address of the selected hot sub-block in the hot buffer; receive a read command for the hot sub-block, based on the host processor accessing the hot buffer; and execute the read command by transmitting the hot sub-block to the host processor, wherein the hot sub-block in the memory is deallocated by the host processor after being transmitted to the host processor.

The host processor may be configured to access the hot buffer of the memory device using memory-mapped input/output (MMIO).

The instructions, when executed by the processing unit, may cause the memory device to delete the address of the selected hot sub-block from in the hot buffer after the hot sub-block is transmitted to the host processor.

The memory device may include a secondary memory device, and the hot sub-block may be stored in a main memory device of the host processor after information about the hot sub-block is transmitted to the host processor.

The memory may include a first memory zone and a second memory zone, wherein, the instructions, when executed by the processing unit, may cause the memory device to: merge, into a superblock, among those of the memory blocks which are stored in the first memory zone, memory blocks having respective access counts that are less than an access count threshold; configure the merged superblock as the second memory zone; and limit counting a number of times accessing the merged superblock.

The memory may include a first memory zone and a second memory zone, wherein, the instructions, when executed by the processing unit, may cause the memory device to: based on an access to a superblock stored in the second memory zone, obtain some of the memory blocks by splitting the accessed superblock thereinto; configure the splitted memory blocks as the first memory zone; and count a number of times accessing the splitted memory blocks.

In another general aspect, a method is performed by a memory device, the method is for managing a memory in the memory device, and the method includes: selecting, from among memory blocks stored in the memory of the memory device, candidate hot memory blocks, the selecting based on access counts of the respective memory blocks stored in the memory of the memory device; selecting a hot sub-block based on access counts of respective sub-blocks, including the hot sub-block, split from the selected candidate hot memory blocks; and transmitting the selected hot sub-block to a host processor, based on a memory command regarding the hot sub-block, wherein the memory command is received from the host processor by the memory device.

The candidate hot memory blocks may be selected based on having respective access counts greater than a first access count threshold, and the selecting of the hot sub-block may include: splitting each of the selected candidate hot memory blocks into the sub-blocks; and selecting, as the hot sub-block, from among the split sub-blocks, a sub-block having an access count that is greater than or equal to a second access count threshold.

The selecting of the candidate hot memory blocks may include determining the access counts of the memory blocks during a first time range, and the selecting of the hot sub-block includes determining access counts each of the respective sub-blocks during a second time range that at least partially follows the first time range.

The method may further include: storing an address of the selected hot sub-block in a hot buffer of the memory device, and the transmitting of the hot sub-block to the host processor may include: receiving a read command for the hot sub-block, based on the host processor accessing the hot buffer; and transmitting the hot sub-block to the host processor, based on the read command, wherein the hot sub-block in the memory is deallocated by the host processor after being transmitted to the host processor.

The method may further include: deleting the address of the selected hot sub-block, which is stored in the hot buffer, after the hot sub-block is transmitted to the host processor.

The memory device may include a secondary memory device, and the hot sub-block may be stored in a main memory device of the host processor after information about the hot sub-block is transmitted to the host processor.

The memory of the memory device may include a first memory zone and a second memory zone, wherein the method may further include: merging, into a superblock, among those of the memory blocks which are stored in the first memory zone, memory blocks having respective access counts that are less than an access count threshold; configuring the merged superblock as the second memory zone; and limiting counting a number of times accessing the merged superblock.

The memory of the memory device may include a first memory zone and a second memory zone, and the method may further include: based on an occurrence of access to a superblock stored in the second memory zone, obtaining memory blocks by splitting the accessed superblock; configuring the memory blocks obtained through the split as the first memory zone; and counting a number of times accessing the memory blocks obtained through the split.

A non-transitory computer-readable storage medium may store instructions that, when executed by a processor, cause the processor to perform any of the methods.

Other features and aspects will be apparent from the following detailed description, the drawings, and the claims.

### BRIEF DESCRIPTION OF THE DRAWINGS

FIG. 1 illustrates an example of a memory system, according to one or more embodiments.

FIG. 2 illustrates an example of a memory management method performed by a memory device, according to one or more embodiments.

FIG. 3 illustrates an example configuration of a memory device, according to one or more embodiments.

FIG. 4 illustrates an example of an operation of selecting a hot sub-block by a memory device, according to one or more embodiments.

FIG. 5 illustrates an example of an operation of moving a hot sub-block from a second memory device to a first memory device in a memory system, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

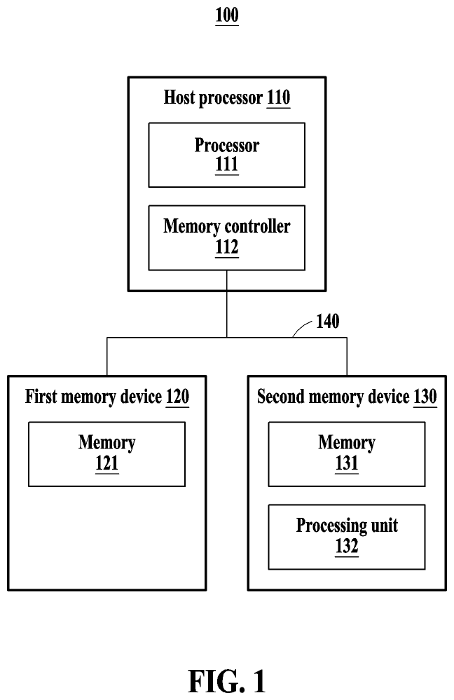

FIG. 1 illustrates an example of a memory system, according to one or more embodiments.

A memory system 100 may include a host processor 110, a first memory device 120, a second memory device 130, and a bus 140. The memory system 100 may configured as a tiered memory system. The tiered memory system splits and manages memory devices connected to the host processor 110 into tiers. In the tiered memory system, a memory device in an upper tier may have a fast access speed and/or a small capacity (e.g., the first memory device 120), and a memory device in a lower tier (e.g., the second memory device 130) may have a slow access speed and/or a large capacity. In short, higher tiers may consist of higher performance memory devices.

The host processor 110 may perform a main operation (e.g., read or write) and/or a control function of the memory system 100. The host processor 110 may include at least one processor 111 and a memory controller 112. The at least one processor 111 may include, for example, a central processing unit (CPU), a graphics processing unit (GPU), and/or a neural processing unit (NPU), as non-limiting examples. The memory controller 112 may control data communication with a memory device (e.g., the first memory device 120 and the second memory device 130) connected to the host processor 110.

The first memory device 120 may be a memory device in an upper tier of memory in the memory system. The first memory device 120 may include a main memory device of the host processor 110. For example, the first memory device 120 may be a dynamic random-access memory (DRAM) device/bank. The first memory device 120 may include a memory 121. The memory 121 of the first memory device 120 may be directly connected to the host processor 110 and may be used as the main backing storage for a memory address space of the host processor 110. The first memory device 120 may be connected to the host processor 110 via a memory bus (e.g., a double data rate (DDR) memory interface-based memory bus).

The second memory device 130 may be a memory device in a lower tier of memory in the memory system. The second memory device 130 may function as a secondary memory device of the host processor 110. For example, the second memory device 130 may be a Type 3 Compute Express Link (CXL) memory device (herein, also referred to as a CXL memory device). The second memory device 130 may receive a command from the host processor 110 (e.g., the memory controller 112 of the host processor 110) and process data based on the received command. The second memory device 130 may be connected to the host processor 110 via a peripheral component interconnect express (PCIe) bus (e.g., a CXL interface-based PCIe bus), for example.

The second memory device 130 may include a memory 131 and a processing unit 132. The second memory device 130 may include a CXL controller, the processing unit 132, a memory controller (not shown), and the memory 131. The CXL controller may communicate with the host processor 110 according to a CXL protocol. The memory controller may obtain and/or generate a command based on a request from the host processor 110 and transmit the command to the memory 131. The processing unit 132 of the second memory device 130 may include a near-memory processing unit. The near-memory processing unit may include the processing unit located between the CXL controller and the memory controller 112 and may perform an operation inside the second memory device 130.

The host processor 110 may store (e.g., cache) more frequently used data in the first memory device 120 (e.g., a DRAM device) and store less frequently used data in the second memory device 130 (e.g., a CXL memory device). The host processor 110 may move data between the first memory device 120 and the second memory device 130 by continuously tracking usage frequency (e.g., access counts) of units of data (e.g., blocks and sub-blocks) in the memory system.

As described below, the processing unit 132 of the second memory device 130 may detect that memory blocks stored in the second memory device 130 are accessed frequently and may store information about corresponding data to be moved to the first memory device 120 in a certain memory area. The processing unit 132 of the second memory device 130 may determine, instead of the host processor 110, which data is to be moved from the second memory device 130 to the first memory device 120. As a result, the load on the host processor 110 of moving data between the first memory device 120 and the second memory device 130 may be reduced.

Likewise, the host processor 110 may move, among memory blocks stored in the first memory device 120, memory blocks that satisfy a demotion condition from the first memory device 120 to the second memory device 130. The first memory device 120 may not internally include a processing unit; instead, it may be the host processor 110 that determines which memory blocks of the first memory device 120 satisfy the demotion condition. The demotion condition may include, for example, whether a memory block (or a sub-block) of the first memory device 120 has an access count below a threshold access count (e.g., the hot access threshold), where each block's access count is for a certain duration/window of time (e.g., only accesses with the window are included in a block's access count).

The first memory device 120 and the second memory device 130 may manage a memory (e.g., the memory 121 and the memory 131) using memory blocks management units (the devices may be block-based storage devices). The block size of the first memory device 120 may be smaller than the block size of the second memory device 130. For example, the block size of the first memory device 120 may be 4 kilobytes (KB), and the block size of the second memory device 130 may be 2 megabytes (MB) and/or 1 gigabyte (GB) (or 2 GB). Since there is a difference between the block sizes of the first memory device 120 and the second memory device 130, to move data between the first memory device 120 and the second memory device 130, the memory system 100 may process some of the memory blocks of the second memory device 130 as memory blocks of the first memory device 120 or may process at least some of the memory blocks of the first memory device 120 as a group of memory blocks of the first memory device 120. For classification, the memory blocks of the second memory device 130 may be referred to as a ‘memory blocks’ and the memory blocks of the first memory device 120 may be referred to as ‘sub-blocks’, meaning that they have a smaller size than the memory blocks of the second memory device 130.

FIG. 1 mainly describes the host processor 110 of the memory system 100 as being connected to two memory devices, but implementations are not limited thereto; the memory system 100 may include three or more memory devices, and/or the host processor 110 may be connected to three or more memory devices.

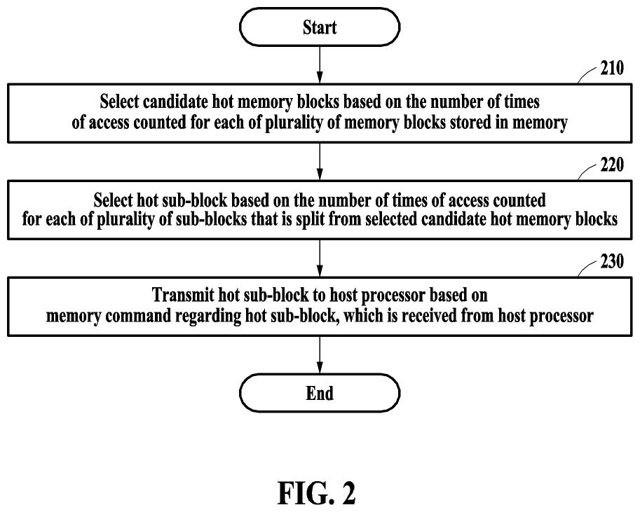

FIG. 2 illustrates an example of a memory management method performed by a memory device, according to one or more embodiments.

A memory device (e.g., the second memory device 130 of FIG. 1) may include a memory a processing unit (possibly multiple). The memory device may be connected to a host processor (e.g., the host processor 110 of FIG. 1) through an interface (e.g., a CXL protocol based-PCIe interface). The memory may store instructions. The processing unit may include a processing circuit. The instructions, when individually or collectively executed by the processing unit, may cause the memory device to perform the operation(s) indicated by the instructions.

The memory of the memory device (e.g., the second memory device 130 of FIG. 1) may store a memory block of a cold class. A memory of another memory device (e.g., the first memory device 120 of FIG. 1) may store a memory sub-block of a hot class (also referred to as a hot sub-block). The classes of memory blocks may be distinguished based on an access characteristic of the memory blocks/sub-blocks, for example, the number of times being accessed, a rate of being accessed (e.g., frequency), recency of access, and/or the like. A representative characteristic is an access count, which is a number of times a block/sub-block is accessed within a window of time.

The memory blocks of the hot class may be defined as sub-blocks that are accessed more than the threshold number of times during a certain time duration/window (i.e., those whose access counts exceed the threshold). The memory blocks of the cold class may be defined as memory blocks that are accessed less than the threshold number of times during the certain time duration/window. The time window may be a period or an epoch. Put another way, the hot-cold threshold number of times is the number of times of access that determines whether a sub-block is a hot sub-block. For example, the threshold number of times determining hot access may be set by a user.

The memory device may determine (e.g., select or detect) some of the memory blocks of the cold class that should be changed from being classified as memory blocks of the cold class to memory blocks of the hot class based on the access counts of the respective memory blocks stored in the memory of the memory device. Hereinafter, the operations of the memory device are described in detail.

In operation 210, the memory device may select candidate hot memory blocks based on the access counts of the respective memory blocks stored in a memory (e.g., the memory 131 of FIG. 1).

The memory device may determine the access counts by counting the number of times each of the memory blocks is accessed. The counting may be performed regardless of what portion of a memory block is accessed. That is to say, the access count of a given memory block is the number of times any portion of the given memory block is accessed (without regard for which sub-block therein is accessed). A processing unit (e.g., the processing unit 132 of FIG. 1) of the memory device may perform the counting to maintain the access counts of the memory blocks. The memory blocks may have a block size (e.g., 2 MB) specified for the memory device (block size may vary by type or configuration of the memory device) . For example, the access count may be computed as a moving time window of accesses, i.e., the number of accesses within the time window.

The memory device may select, as the previously-mentioned candidate hot memory blocks, from among its memory blocks, any memory blocks determined to have an access count that is greater than or equal a first threshold access count.

Hot block selection is not limited to the previous example. For example, the memory device may select, as candidate hot memory blocks, memory blocks (e.g., a predetermined number of memory block(s)) in the order of decreasing access count (the blocks with the highest access counts first, or the top-N access counts). To select between hot memory blocks having the same access count, the memory device may select/prefer the block(s) having the latest (most recent) access time.

In operation 220, the memory device may select a hot sub-block (e.g., in the first memory device) based on the access counts of respective sub-blocks (e.g., in the second memory device) that make up (e.g., have been split up from) the selected candidate hot memory blocks.

For example, the memory device (e.g., the second memory device) may split each of the selected candidate hot memory blocks into sub-blocks. As noted, a sub-block may have a block size (e.g., 4 KB) specified for the other memory device (e.g., the first memory device).

The memory device (e.g., second memory device) may maintain access counts of the respective sub-blocks. The sub-block access counts may be maintained independently from the access counts of the memory blocks. For example, the memory device may set the accessing counts of the respective sub-blocks as an initial value and may count the number of accesses occurring after the candidate hot memory blocks are split into the sub-blocks. The initial value may be set to the same value (e.g., 0) for each of the sub-blocks. Alternatively, the initial value may be set to the number of times accessing the memory block that includes the corresponding sub-block.

The memory device may select, as the hot sub-block, from among the split sub-blocks, a sub-block having an access count that is greater than or equal a second threshold access count. The second threshold access count may determine selection of the hot sub-block. The second threshold access count may be the same as or different from the first threshold access count.

However, examples are not limited thereto, and the memory device may select, as the hot sub-block, from among the split sub-blocks, sub-block(s) (e.g., a predetermined number of sub-block(s)) in the order of decreasing access count (i.e., top-N largest). When the memory device must select, from among the sub-blocks, one or more sub-blocks among sub-blocks having the same access count, the memory device may select the hot sub-block(s) having the most recent access times.

The memory device (e.g. second memory device) may determine/count the access counts the respective memory blocks during a first time range. More specifically, the memory device may select the candidate hot memory blocks based on the access counts of the memory blocks after the first time range elapses and may split each of the selected candidate hot memory blocks into corresponding sub-blocks. The memory device may determine access counts of the sub-blocks during a second time range that follows the first time range.

The memory device may periodically repeat selecting (e.g., operation 210) the candidate hot memory blocks, selecting (e.g., operation 220) the hot sub-block(s), and transmitting (e.g., operation 230) the hot sub-block(s). The first time range and the the second time range may overlap.

The first threshold access count (to select the candidate hot memory blocks) may be determined based on a ratio of a time length of the first time range to a time length of the period including the first time range and the second time range. For example, the first threshold access count may be determined based on a value obtained by multiplying the number of times of hot access (e.g., the number of times of access used in defining a memory block of a hot class) by the ratio. For example, when the ratio of the first time range of the period is 0.75, the first threshold access count may be 0.75 times the number of times of hot access.

The second threshold access count (to select the hot sub-block) may be determined based on an initial value of the number of times accessing the sub-blocks. For example, when the memory device sets the initial value of the number of times accessing the sub-blocks as a value (e.g., 0) that is common to the sub-blocks, the number of times of second threshold access may be determined based on a second ratio of a time length of the second time range to the time length of the period. For example, in the period, when the ratio of the second time range is 0.25, the second threshold access count may be determined to be 0.25 times the number of times of hot access. For example, when the memory device sets the initial value of the number of times accessing the sub-blocks as the number of times of access of the memory block including each sub-block (e.g., the number of times of access counted for the memory block during the first time range), the second threshold access count may be determined based on the number of times of hot access. For example, the second threshold access count may be determined to be a value that is the same as the number of times of hot access.

In operation 230, the memory device may transmit the hot sub-block(s) selected at operation 220 to the host processor, based on a memory command (e.g., a read command) regarding the hot sub-block, which is received from the host processor. The memory device (e.g., second memory device) may transmit the hot sub-block (or data stored in the hot sub-block) to the host processor, based on the memory command (e.g., the read command) regarding the hot sub-block, which is received from the host processor.

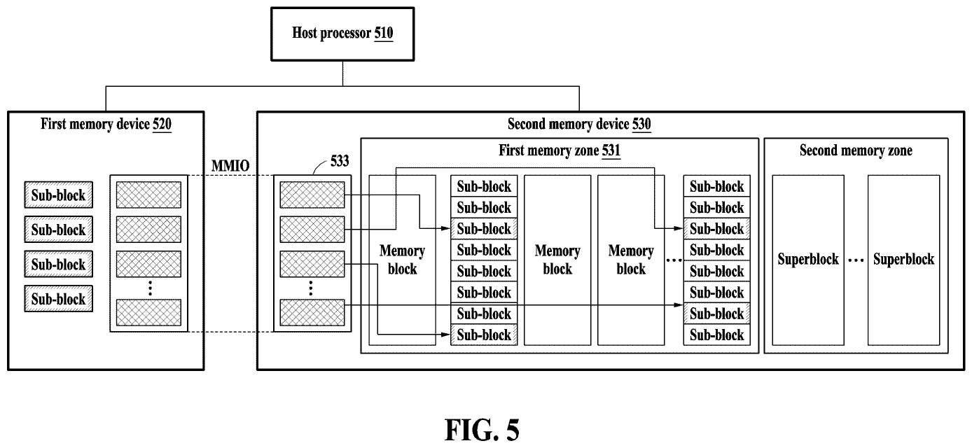

As described with reference to FIG. 5, the host processor may store the hot sub-block (or data stored in the hot sub-block) in the other memory device (e.g., the first memory device 120 of FIG. 1) and may deallocate (e.g., free) the hot sub-block among the memory blocks of the memory device (e.g., the second memory device), thereby moving the hot sub-block from the memory device to the other memory device.

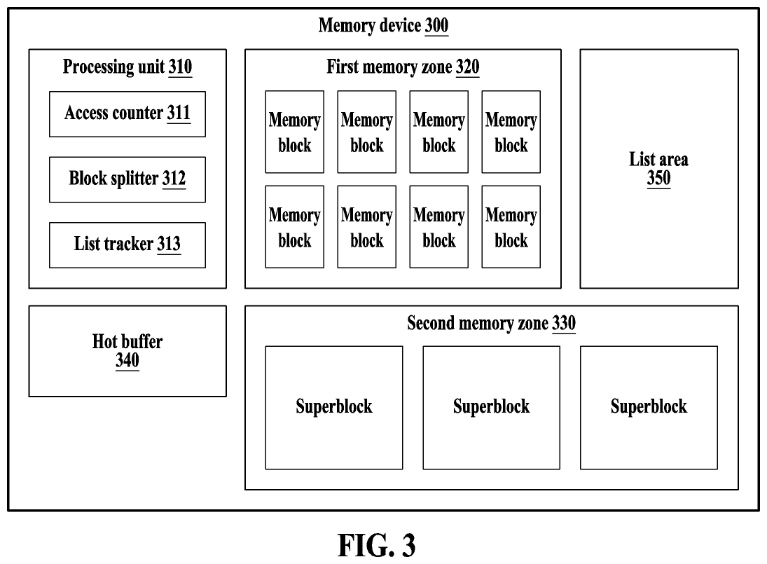

FIG. 3 illustrates an example configuration of a memory device, according to one or more embodiments.

A memory device 300 (e.g., the second memory device 130 of FIG. 1) may include a processing unit 310 (e.g., the processing unit 132 of FIG. 1) and a memory (e.g., the memory 131 of FIG. 1).

The processing unit 310 may include an access counter 311, a block splitter 312, and a list tracker 313. Each of the access counter 311, the block splitter 312, and the list tracker 313 may include a processing circuit that is designed to perform an operation assigned to a corresponding configuration, or these components may be implemented by modules of code/instructions configured to cause the same actions to be performed.

While the processing unit 310 may include the access counter 311, the block splitter 312, and the list tracker 313, examples are not limited thereto. For example, each of the access counter 311, the block splitter 312, and the list tracker 313 may be a respective software module (a unit of instructions executable by the processing unit 310). When the access counter 311, the block splitter 312, and/or the list tracker 313 is implemented as respective software modules, such software modules may include instructions stored in the memory and executed by the processing unit 310. An operation of the software module may be understood as the operation of the processing unit 310.

The access counter 311 (e.g. access counter included in the second memory device 130 of FIG. 1) may count the number of times accessing each of memory blocks and/or each of sub-blocks. As described above with reference to FIG. 2, the access counter 311 may count the number of times accessing each of the memory blocks and then count the number of times accessing each of the sub-blocks. The access counter 311 may count the number of times accessing based on a hash algorithm (e.g., a hash table), a count-min (CM) sketch algorithm, and/or a one-to-one mapping algorithm. The access counter 311 may include multiple counters. The counters used to count the number of times accessing the memory blocks may be reused to count the number of times accessing each of the sub-blocks.

The block splitter 312 may split candidate hot memory blocks into sub-blocks. As described above with reference to FIG. 2, the block splitter 312 may split the candidate hot memory blocks having a first size (e.g., 2 MB) into sub-blocks having a second size (e.g., 4 KB). The splitting of the memory block into the sub-blocks may include splitting a physical address (e.g., a device physical address (DPA)) of the memory block into physical addresses of the sub-blocks. The block splitter 312 may transmit, to the access counter 311, information (e.g., the physical addresses of the sub-blocks) about the split sub-blocks. The access counter 311 may count the number of times accessing each of the sub-blocks using the information about the split sub-blocks received from the block splitter 312.

The list tracker 313 may sort at least one memory block of the memory blocks, based on the access counts of the respective memory blocks. The list tracker 313 may manage (e.g., generate, store, update, or modify) the result of sorting the memory blocks as a list. The list tracker 313 may sort the memory blocks based on their access counts (e.g., frequency) and/or their latest access times.

The list tracker 313 may manage a first list (e.g., a least frequently used (LFU) list) in which memory blocks are sorted based on their access counts (e.g., in ascending order (or in descending order) according to their access counts). The list tracker 313 may manage a second list (e.g., a least recently used (LRU) list) in which memory blocks are sorted based on their latest access times (e.g., in ascending order according to their latest access times). The processing unit 310 may select the candidate hot memory blocks from among the memory blocks based on the first list and/or the second list.

The memory device 300 may manage memory blocks having multiple classes inside the memory, based on the numbers of times accessing the memory. The classes managed inside the memory may include a cold class and a coldest class. For reference, a memory block of a hot class may be stored in an external memory device (e.g., the first memory device 120 of FIG. 1) of the memory device 300. As described above, the memory block of the hot class may have a size (e.g., 4 KB) that is smaller than the size (e.g., 2 MB) of the memory block of the cold class. The memory block of the coldest class may have a size (e.g., 1 GB or 2 GB) that is larger than the size (e.g., 2 MB) of the memory block of the cold class. The memory block of the hot class may be expressed as a ‘hot sub-block,’ the memory block of the cold class may be expressed as a ‘memory block,’ and the memory block of the coldest class may be expressed as a ‘superblock.’

The memory block of the coldest class may refer to a memory block that is not accessed for a certain time. The certain time used to determine the memory block of the coldest class may be greater than or equal to a certain time used to determine the memory block of the hot class and/or the cold class.

For example, the memory blocks of the hot class may be those that are accessed more than the number of times of hot access (first access count threshold) during the most recent first time length. The memory blocks of the cold class may be those that are accessed less than the number of times of hot access (second access count threshold) during the most recent first time length and that are accessed one or more times during the latest second time length. The memory blocks of the coldest class may be those that are not accessed during the latest second time length.

For example, the memory may include a first memory zone 320 and a second memory zone 330. The first memory zone 320 may be a zone where the memory blocks of the cold class are stored among the memories of a second memory device. The second memory zone 330 may be a zone where the memory blocks of the coldest class are stored among the memories of the second memory device. The first memory zone 320 and/or the second memory zone 330 may not be fixedly designated by a physical address but rather are properties that may be set as a configuration for a certain memory area. As described below, when switching a memory area between the cold class and the coldest class, the memory device 300 may set corresponding memory blocks as the cold class or the coldest class instead of changing the physical storage location of the memory blocks.

The second memory zone 330 may be set as a compressed memory pool inside the memory device 300. The compressed memory pool may be a memory area in which pieces of data are stored in compressed form. When the second memory zone 330 is set as a compressed memory pool, changing a given memory block from the first memory zone 320 to the second memory zone 330 may include compressing data of the given memory block, and changing a given memory block from the second memory zone 330 to the first memory zone 320 may include decompressing data of the certain memory block.

The memory may further include a hot buffer 340 and a list area 350.

The hot buffer 340 may store information about a sub-block selected as a hot sub-block by the memory device 300. The hot buffer 340 may include a ring buffer or a circular buffer. For example, information about the sub-block may include pieces of information about a physical address (e.g., a DPA) of a hot sub-block, the number of times of access (access count), and a selection basis of a hot sub-block. The information about the selection basis of the hot sub-block may be the number of times of access or a list (e.g., an LFU list or an LRU list).

The information about the sub-block may be implemented as a 64-bit descriptor such that a predetermined number of high-order bits (e.g., 64-N bits, and here, N is a natural number) may represent a DPA of the hot sub-block, a predetermined number of high-order bits (e.g., N-1 bits, and here, N is a natural number) following the bits representing the DPA of the hot sub-block may represent the access count of the sub-block (e.g., a counter value), and a least significant bit (LSB) may indicate the selection basis of the hot sub-block among the number of times of access of the hot sub-block or list. Here, N may be determined based on the size of the memory block of the hot class, that is, the sub-block.

The list area 350 may be a memory area that stores a list for at least one of the memory blocks of the first memory zone 320 managed by the list tracker 313.

The memory device 300 may merge, into a superblock, among the memory blocks stored in the first memory zone 320, memory blocks having access counts less than the access count threshold access (e.g., 0 times). The memory device 300 may merge, into a superblock, memory blocks based on the fact that memory blocks included in an address space that is equal to the size of the superblock from one memory block has an access count that is less than or equal to the access count threshold. The superblocks are memory blocks of the coldest class and may have a block size that is larger than the block size of the memory blocks of the cold class (herein, also simply referred to as a ‘memory block’).

The memory device 300 may configure the merged superblock as the second memory zone 330. The memory device 300 may not track (e.g., count) the number of times accessing the memory blocks of the coldest class. For example, the memory device 300 may limit counting the number of times accessing the merged superblock.

Based on the occurrence of the access to the superblock stored in the second memory zone 330, the memory device 300 may obtain the memory blocks by splitting the accessed superblock. The memory device 300 may configure the memory blocks obtained through the split as the first memory zone 320. The memory device 300 may count the number of times accessing the memory blocks obtained through the split.

The memory device 300 may split the accessed superblock during the second time range into the memory blocks when the access to the superblock occurs during the first time range. The first time range may be a time during which the memory device 300 counts the number of times accessing the memory blocks of the first memory zone 320. That is, the memory device 300 may wait for the first time range to elapse even when access to the superblock occurs at a certain timepoint included in the first time range, and when the first time range elapses, the memory device 300 may split the accessed superblock (during the second time range) into the memory blocks.

When the access to the superblock occurs during the first time range, the memory device 300 may split the superblock accessed in a threshold time (e.g., immediately) into the memory blocks. When the access to the superblock occurs at a certain timepoint included in the first time range, the memory device 300 may split the superblock into the memory blocks in the threshold time and may count the number of times accessing each of the memory blocks obtained through the split using the access counter 311 during the remaining first time range. When the number of times accessing at least one memory block among the memory blocks obtained through the split during the remaining first time range is greater than or equal to the first access count threshold (e.g., the number of times of threshold access to select the candidate hot memory blocks), the memory device 300 may select at least one memory block among the memory blocks obtained through the split as the candidate hot memory blocks.

While the memory of the memory device 300 is mainly described as including the second memory zone 330, examples are not limited thereto. The second memory zone 330 may be stored in an external memory device of the memory device 300 (e.g., a separate additional memory device that is distinguished from the first memory device 120 and the second memory device 130 of FIG. 1). The external memory device may be an external memory pool.

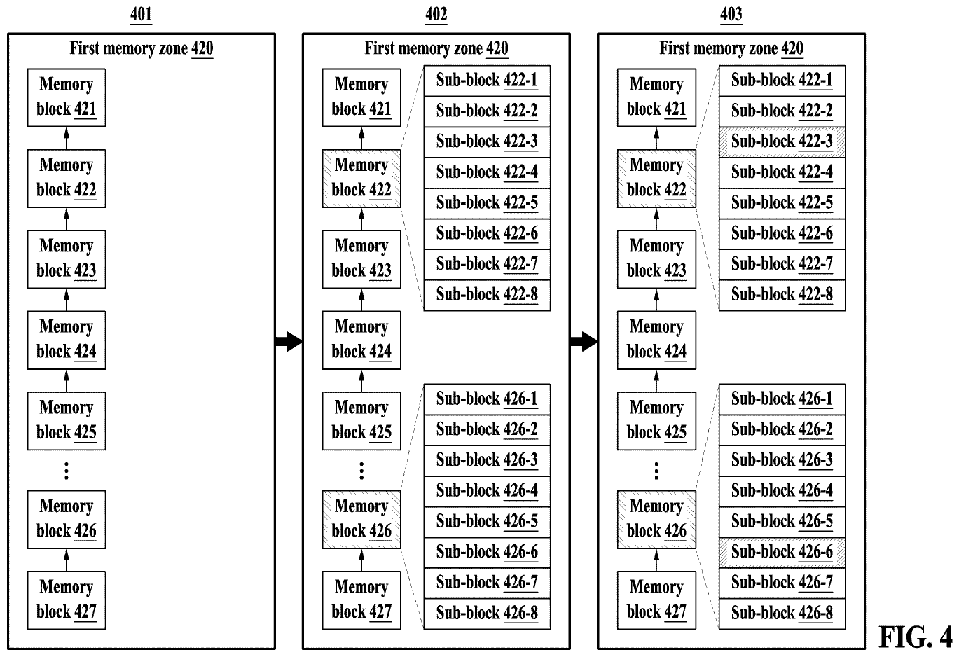

FIG. 4 illustrates an example of an operation of selecting a hot sub-block by a memory device, according to one or more embodiments.

A memory of a memory device (e.g., the second memory device 130 of FIG. 1) may include a first memory zone (e.g., the first memory zone 320 of FIG. 3). The first memory zone may include memory blocks of a cold class.

In state 401, memory blocks 421-427 may be logically sorted according to a list (e.g., a list generated by the list tracker 313 of FIG. 3), based on access counts of the respective memory blocks. The memory device may maintain/accumulate the access counts of the respective memory blocks.

In a state 402, the memory device may select, from among the memory blocks 421-427, the memory blocks 422 and 426 as candidate hot memory blocks based on the access counts of the respective memory blocks 421-427. The memory device may split the memory block 422 into sub-blocks 422-1 to 422-8 and may split the memory block 426 into sub-blocks 426-1 to 426-8. FIG. 4 shows one memory block being split into eight sub-blocks, but examples are not limited thereto, and one memory block may be split into a different number of sub-blocks depending on the block size and sub-block size. The memory device may determine (e.g., tally/count) the access counts of the respective sub-blocks 422-1 to 422-8 and of the sub-blocks 426-1 to 426-8.

In state 403, the memory device may select the sub-block 422-3 and the sub-block 426-6 as hot sub-blocks, based on the access counts of the respective sub-blocks. Although not clearly shown in FIG. 4, the memory device may store, in a hot buffer, information (e.g., a 64-bit descriptor) about the sub-block 422-3 and the sub-block 426-6 (e.g., indicating that they have been selected as the hot sub-blocks).

FIG. 5 illustrates an example operation of moving a hot sub-block from a second memory device to a first memory device in a memory system, according to one or more embodiments.

A memory system (e.g., the memory system 100 of FIG. 1) may include a host processor 510 (e.g., the host processor 110 of FIG. 1), a first memory device 520 (e.g., the first memory device 120 of FIG. 1), and a second memory device 530 (e.g., the second memory device 130 of FIG. 1 and the memory device 300 of FIG. 3).

Referring to FIG. 5, the second memory device 530 may select a hot sub-block. The second memory device 530 may store an address of the selected hot sub-block into a hot buffer 533. The selection of the hot sub-block of the second memory device 530 may be generally performed in the same or similar manner as described with reference to FIGS. 1 to 4.

The host processor 510 may transmit a read command for the hot sub-block to the second memory device 530 using the address of the hot sub-block as accessed from the hot buffer 533. For example, the host processor 510 may determine that the period of the hot sub-block has elapsed based on a timer managed by the host processor 510 and may access the hot buffer 533. In another example, the second memory device 530 may transmit a signal (e.g., an interrupt or a request) to the host processor 510, based on the selection of the hot sub-block of the second memory device 530 and/or based on the storage of the address of the hot sub-block into the hot buffer 533. The host processor 510 may transmit the read command for the hot sub-block to the second memory device 530, in response to the signal received from the second memory device 530.

The host processor 510 may access the hot buffer 533 of the memory device as part of a memory-mapped input/output (MMIO) addressing scheme.

The second memory device 530 may receive the read command for the hot sub-block, where the read request is based on the host processor 510 accessing the hot buffer 533. The second memory device 530 may transmit the hot sub-block (or data stored in the hot sub-block) to the host processor 510, based on the read command. For example, the second memory device 530 may transmit a signal including/encoding the data stored in the hot sub-block to the host processor 510 as a response to the read command.

After the hot sub-block is transmitted to the host processor 510, the second memory device 530 may delete the address of the hot sub-block from the hot buffer 533. After the address of the hot sub-block is deleted, the second memory device 530 may repeat, among the memory blocks included in a first memory zone 531 of the second memory device 530, the selection of candidate hot memory blocks, the selection of a hot sub-block, and the transmission of a hot sub-block.

The host processor 510 may store the hot sub-block (or data stored in the hot sub-block) in the first memory device 520 (e.g., a main memory device of the host processor 510). After the hot sub-block is stored in the first memory device 520, the host processor 510 may deallocate the hot sub-block (or some areas of the memory of the second memory device 530 corresponding to the hot sub-block). As a result, the hot sub-block may finish being moved from the second memory device 530 (e.g., a secondary memory device of the host processor 510) to the first memory device 520 (e.g., the main memory device of the host processor 510).

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

Software may include a computer program, a piece of code, an instruction, or some combination thereof, to independently or collectively instruct or configure the processing device to operate as desired. Software and data may be embodied permanently or temporarily in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like (but not a signal per se). Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

The computing apparatuses, the electronic devices, the processors, the memories, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A memory device comprising:
a memory storing instructions; and
a processing unit comprising one or more processors,
wherein the memory device is connected with a host processor through an interface, and
wherein, the instructions, when executed by the processing unit, cause the memory device to:
select, from among memory blocks stored in the memory, candidate hot memory blocks, the selecting based on access counts of the respective memory blocks stored in the memory;
select a hot sub-block based on a number access counts of respective sub-blocks, including the hot sub-block, split from the selected candidate hot memory blocks; and
transmit the selected hot sub-block to the host processor, based on a memory command regarding the hot sub-block, wherein the memory command is received from the host processor by the processing unit.

2. The memory device of claim 1, wherein, the instructions, when executed by the processing unit, cause the memory device to:
select, as the candidate hot memory blocks, those of the memory blocks having access counts greater than a first access count threshold;
split each of the selected candidate hot memory blocks into the sub-blocks; and
select, the hot sub-block, from among the split sub-blocks, based on the hot sub-block having an access count that is greater than a second access count threshold.

3. The memory device of claim 1, wherein, the instructions, when executed by the processing unit, cause the memory device to:
determine the access counts of the respective memory blocks during a first time range; and
determine the access counts each of the respective sub-blocks during a second time range that at least partially follows the first time range.

4. The memory device of claim 3, wherein the first access count threshold is determined based on a ratio of a time length of the first time range to a time length of a period comprising the first time range and the second time range.

5. The memory device of claim 1, wherein a block size of the memory blocks is larger than a block size of the sub-blocks.

6. The memory device of claim 1, wherein the memory further comprises a hot buffer,
wherein, the instructions, when executed by the processing unit, cause the memory device to:
store an address of the selected hot sub-block in the hot buffer;
receive a read command for the hot sub-block, based on the host processor accessing the hot buffer; and
execute the read command by transmitting the hot sub-block to the host processor,
wherein the hot sub-block in the memory is deallocated by the host processor after being transmitted to the host processor.

7. The memory device of claim 6, wherein the host processor is configured to access the hot buffer of the memory device using memory-mapped input/output (MMIO).

8. The memory device of claim 6, wherein, the instructions, when executed by the processing unit, cause the memory device to delete the address of the selected hot sub-block from in the hot buffer after the hot sub-block is transmitted to the host processor.

9. The memory device of claim 1, wherein
the memory device comprises a secondary memory device, and
the hot sub-block is stored in a main memory device of the host processor after information about the hot sub-block is transmitted to the host processor.

10. The memory device of claim 1, wherein the memory comprises a first memory zone and a second memory zone,
wherein, the instructions, when executed by the processing unit, cause the memory device to:
merge, into a superblock, among those of the memory blocks which are stored in the first memory zone, memory blocks having respective access counts that are less than an access count threshold;
configure the merged superblock as the second memory zone; and
limit counting a number of times accessing the merged superblock.

11. The memory device of claim 1, wherein the memory comprises a first memory zone and a second memory zone,
wherein, the instructions, when executed by the processing unit, cause the memory device to:
based on an access to a superblock stored in the second memory zone, obtain some of the memory blocks by splitting the accessed superblock thereinto;
configure the splitted memory blocks as the first memory zone; and
count a number of times accessing the splitted memory blocks.

12. A method, performed by a memory device, of managing a memory in the memory device, the method comprising:
selecting, from among memory blocks stored in the memory of the memory device, candidate hot memory blocks, the selecting based on access counts of the respective memory blocks stored in the memory of the memory device;
selecting a hot sub-block based on access counts of respective sub-blocks, including the hot sub-block, split from the selected candidate hot memory blocks; and
transmitting the selected hot sub-block to a host processor, based on a memory command regarding the hot sub-block, wherein the memory command is received from the host processor by the memory device.

13. The method of claim 12, wherein
the candidate hot memory blocks are selected based on having respective access counts greater than a first access count threshold, and
the selecting of the hot sub-block comprises:
splitting each of the selected candidate hot memory blocks into the sub-blocks; and
selecting, as the hot sub-block, from among the split sub-blocks, a sub-block having an access count that is greater than or equal to a second access count threshold.

14. The method of claim 12, wherein
the selecting of the candidate hot memory blocks comprises determining the access counts of the memory blocks during a first time range, and
the selecting of the hot sub-block comprises determining access counts each of the respective sub-blocks during a second time range that at least partially follows the first time range.

15. The method of claim 12, further comprising:
storing an address of the selected hot sub-block in a hot buffer of the memory device,
wherein the transmitting of the hot sub-block to the host processor comprises:
receiving a read command for the hot sub-block, based on the host processor accessing the hot buffer; and
transmitting the hot sub-block to the host processor, based on the read command,
wherein the hot sub-block in the memory is deallocated by the host processor after being transmitted to the host processor.

16. The method of claim 15, further comprising:
deleting the address of the selected hot sub-block, which is stored in the hot buffer, after the hot sub-block is transmitted to the host processor.

17. The method of claim 12, wherein
the memory device comprises a secondary memory device, and
the hot sub-block is stored in a main memory device of the host processor after information about the hot sub-block is transmitted to the host processor.

18. The method of claim 12, wherein the memory of the memory device comprises a first memory zone and a second memory zone,
wherein the method further comprises:
merging, into a superblock, among those of the memory blocks which are stored in the first memory zone, memory blocks having respective access counts that are less than an access count threshold;
configuring the merged superblock as the second memory zone; and
limiting counting a number of times accessing the merged superblock.

19. The method of claim 12, wherein the memory of the memory device comprises a first memory zone and a second memory zone,
wherein the method further comprises:
based on an occurrence of access to a superblock stored in the second memory zone, obtaining memory blocks by splitting the accessed superblock;
configuring the memory blocks obtained through the split as the first memory zone; and
counting a number of times accessing the memory blocks obtained through the split.

20. A non-transitory computer-readable storage medium storing instructions that, when executed by a processor, cause the processor to perform the method of claim 12.
